(19) United States
(12) Patent Application Publication
(10) Pub. No.: US 2021/0114153 A1
(43) Pub. Date: Apr. 22, 2021

(54) SUCTION DEVICE HAVING BLADES, AND METHOD FOR THE PRODUCTION THEREOF

(71) Applicant: GUEHRING KG, Albstadt (DE)

(72) Inventors: Christian GAUGGEL, Heinstetten (DE); Camil Octav Chetreanu-Don, Cluj-Napoca (RO)

(73) Assignee: GUEHRING KG, Albstadt (DE)

(21) Appl. No.: 17/029,571

(22) Filed: Sep. 23, 2020

Related U.S. Application Data
(63) Continuation of application No. PCT/EP2019/059454, filed on Apr. 12, 2019.

(30) Foreign Application Priority Data
Apr. 12, 2018 (DE) 10 2018 108 762.4

(51) Int. Cl. B23Q 11/00; B23C 5/10

(52) U.S. Cl. CPC B23Q 11/0046; B23C 5/10

(57) ABSTRACT

The invention relates to a suction device for suctioning off wood chips and/or dust generated during the cutting machining of a workpiece, in particular for a chuck (10) for receiving a rotationally driven cutting tool (12), particularly a cutting tool for machining CFK materials or other short-chipping materials, comprising a hub portion (14) that can be rotationally driven, which supports a plurality of radial blades (16) that are evenly distributed in a circumferential direction. In each case, a blade entering edge (20) of the blade (16) extends axially away from the hub portion (14) and radially outwards to a ring portion (18) that stabilizes the blades (16) and is concentric with respect to the hub portion (14). The invention further relates to a production method for producing the suction device.

### TECHNICAL FIELD

The invention relates to a suction device for suctioning off woodchips and/or dust that arises during the cutting machining of a workpiece, in particular for a chuck for receiving a rotationally driven cutting tool, in particular a cutting tool for machining CFK materials or other short-chipping materials. The invention further relates to a method for manufacturing such a suction device.

In particular when machining CFK materials or other short-chipping materials, fine woodchips come about while machining, i.e., while separating out fibers of the (CFK) material, which accumulate on the tool and on the workpiece to be machined, and thereby worsen the machining result. In order to avoid this, use is often made of suction devices known from prior art, so as to remove the arising woodchips and/or the dust.

For this purpose, DE 37 34 127 A1 discloses among other things a machine for machining, wherein a suction device is present for the removed woodchips, and has a woodchip catching chamber that is connected with a suction pump. The woodchip catching chamber is here surrounded by a boundary wall, whose edge facing the workpiece is bordered by a passage opening, and simultaneously can be moved in an axial direction and placed on the workpiece surface. However, such a suction device yields an unsatisfactory suction result, since the suction power is too low, and the section pump is only hooked up to individual inflow openings.

Also known from EP 2 422 925 B1 is a removal device for removing particles on a machining unit, wherein an impeller is used to generate an air flow to remove particles that arise during the machining process. The impeller can here be fastened to the machining unit in such a way as to rotate with the machining unit around its machining axis. A separator is additionally provided upstream from the impeller to separate the particles from the air flow before the impeller. However, the suction power achievable in this way proved to be relatively limited due to poorly controllable unbalance forces.

In addition, EP 2 644 318 A1 discloses a tool holder, a tool, and a suction device, which rotates together with the tool, and is designed to remove woodchips that arise while machining a workpiece, wherein the suction device is detachably connected with the tool holder, and has a bell-shaped body, which forms a suction chamber around the tool and has a plurality of openings in its side wall.

Apart from the fact that handing this suction device and assembling the components required for this purpose is both expensive and prone to error, this known apparatus also proves unable to achieve the suction power required for the modern high-performance machining of CFK materials.

Therefore, the object of the invention is to avoid or diminish the disadvantages of prior art. In particular, a suction device for a chuck is to be provided, which while being easy to manufacture and assemble, is characterized by a suction power that nothing so far has come close to achieving. In addition, an economical manufacturing method is to be developed for such a suction device.

The object of the invention is achieved by a suction device with the features in claim 1, and a method for manufacturing a suction device with the features in claim 11.

In other words, a respective blade leading edge or blade inner edge extends from an end of the blade lying radially inward on the hub section outwardly in a radial direction and away from the hub section in an axial direction, i.e., for example in a direction toward a workpiece or toward an end of the suction device on the workpiece side, up to the ring section. A section, for example one shaped like a bell, extending in an axial direction and arranged coaxially to the hub section is thus formed, from which the plurality of radial blades extend radially inward. As a result of this concept, the blade leading edges of the radial blades are each designed and arranged in such a way that a radial distance between a longitudinal axis of the suction device and the respective blade leading edge becomes increasingly larger toward the end on the workpiece side, i.e., toward an end on the ring section side, of the section device.

The advantage to this is that not only does a comparatively large suction opening form in the area of the ring section upstream from the blades, but also an enlarged suction volume, making it possible to raise the suction power of the blades to a level hitherto not achieved. This makes the suction device particularly well suited for suctioning woodchips and/or dust, even when extremely numerous and small woodchips or dust particles come about, e.g., as is the case during the high-performance machining of CFK materials. Tests were able to show that even a stream of woodchips created during this machining process can be safely captured by the impeller and transported away from the workpiece surface.

In turn, the advantage to this is that no suction chamber surrounding the blades needs to be present, since even given an arrangement in a workpiece machining chamber without a suction chamber, the woodchips and/or the dust is reliably transported away. This makes it significantly easier to switch tools during the machining process, since the suction device, and hence a clamping section for receiving a tool, are freely accessible.

Advantageous further developments are the subject of the subclaims.

It is further expedient for an outer diameter of the hub section, the ring section and/or the blades to form a shared, enveloping cylinder, the shell surface of which surrounds the suction device. An especially compact, and thus versatile, suction device can be provided in this way, wherein it has been shown that this configuration allows a significant increase in the permissible speed.

It is also preferred that the outer diameter of the hub section, the ring section and/or the blades form a shared, rotationally symmetrical enveloping surface, the shell surface of which surrounds the suction device. The enveloping cone preferably tapers in an axial direction from the ring section in the direction toward the hub section. This makes it possible to form an enlarged blade surface which simultaneously has a large suction opening, so that the suction power can additionally be increased. The enveloping surface can assume a variety of shapes, so as to influence the respectively required suction power. In the simplest configuration, it is formed by an enveloping cylinder, which keeps the mass of the suction device low, so that the dynamic forces can be controlled even at very high speeds. The enveloping surface can also be comprised of an enveloping cone, which tapers in an axial direction from the ring section in the direction toward the hub section. This makes it possible to form an enlarged blade surface which simultaneously has a large suction opening, so that the suction power can additionally be increased.

In addition, it is advantageous that the blades be positioned in an axial direction and/or in a radial direction and/or in a circumferential direction. It is preferred that the respective longitudinal axes of the blades be inclined relative to a longitudinal axis of the suction device, for example in the circumferential direction to the axial direction, preferably by at least 10°, and further preferably by 15° to 35°. This advantageously makes it possible to enlarge the blade surface, and in particular an acting blade edge length, while the axial extension remains constant.

It is also preferred that the respective longitudinal axes of the blades be inclined relative to a longitudinal axis of the suction device in a radial direction, preferably by at least 15°, and further preferably by 20 to 30°. The longitudinal axis of the suction device here corresponds to a longitudinal axis of the hub section or the ring section. As a result, the suction flow for suctioning the woodchips and/or the dust can be advantageously generated and oriented in a predetermined direction.

A preferred further development is further characterized in that the respective blades have a positive curvature, preferably a consistently positive curvature. As a result, the rotational direction of the hub section can be used in a particularly effective manner to generate the largest possible suction flow or suction power. Alternatively, it is also possible that the blades have a negative curvature.

In particular, it is preferred that the blades be curved in a circumferential direction and/or in a longitudinal axis direction. This makes it possible to achieve an especially advantageous configuration of the blades for generating a suction flow with a flow speed of up to 20 m/s.

In addition, it is advantageous for the blades to have a continuously running blade cross section over more than half the extension length of the suction device along its longitudinal axis. As a result, a large usable blade surface can be used for generating a suction flow. This advantageously enables the shortest possible construction given a high suction power, since a comparatively large portion of the extension length of the suction device can be used for a usable blade length. In other words, then, the largest possible portion of the present extension length of the blades is used to generate the suction flow.

In another advantageous further development, the suction device is inherently integral in design, i.e., consists of a single piece. As a result, for example, the blades of the suction device can be precisely oriented relative to each other and/or to the hub section during manufacture already. Therefore, the tolerances do not depend on any assembly accuracy. In addition, the suction device can thereby be easily mounted as a whole, which has a favorable impact on the manufacturing costs and assembly time.

As pointed out above, the suction device is characterized in that it achieves a suction power hitherto not achieved based on a special blade arrangement and geometry. The blade arrangement and geometry can be optimized in a particularly economical manner by manufacturing the suction device generatively, i.e., additively or in a generative manufacturing process. Generative manufacturing advantageously enables a highly precise formation of complex geometries, for example of the blades.

In addition, it makes sense for the suction device, a clamping section of the chuck for receiving a rotary driven cutting tool, and a shaft section of the chuck to comprise a modular structure, so that the suction device can advantageously also be used independently of the clamping section and the shaft section.

In an especially advantageous further development, the hub section or the suction device is designed integrally with the clamping section of the chuck for receiving a rotary driven cutting tool. This makes it possible to ensure a highly precise centering of the hub section, and hence also of the blades, relative to the clamping section, so that forces caused by unbalances remain easy to control at a reduced assembly-related outlay. An especially smooth running can in this way be ensured for the suction device even at extremely high speeds, with commonly arising assembly errors being precluded at the same time. In other words, the hub section, the clamping section as well as the blades and the ring section are generatively fabricated integrally together. A unit comprised of the hub section, the blades and the ring section will also be referred to as a cage below. As a result, the suction device can be fabricated in a manufacturing process, for example via 3D printing, thereby eliminating the need for time-consuming and cost-intensive finishing and/or assembly.

In addition, it is advantageous for the suction device to be fastened to a shaft section, for example a hollow shaft cone, of the chuck. It is especially preferred that the hollow shaft cone be conventionally fabricated, and that the suction device be printed onto the shaft section, for example via 3D printing. As a consequence, the chuck is fabricated with a hybrid construction method, so that the generatively manufactured suction device can be combined with the shaft section, which is preferably designed as a standard component. This makes it possible to combine the advantages of generative manufacturing with the advantages of conventional fabrication, so that the manufacturing costs can be significantly reduced.

In particular, it is preferred that the suction device be manufactured through selective laser melting (“selective laser melting”). A thin layer of the material to be processed is here applied in powder form to a base plate, and completely melted or remelted via laser radiation. As a consequence, a solid material layer is formed after solidification. The base plate is then lowered by the thickness of the applied layer, and powder is once again applied until all layers have been remelted.

It is additionally advantageous that the suction device preferably be fabricated layer-by-layer from a hub section-side end to a ring section-side end. This makes it possible to produce the geometry of an optimal blade shape, in particular at a hub section-side end.

It is further preferred that at least one channel be formed in the hub section, thereby advantageously saving on material inside of the hub section, and thus reducing the manufacturing time, in particular 3D printing time. It is additionally advantageous that the channel have a C-shaped cross section, and preferably be curved concentrically to the longitudinal axis of the suction device. An advantageous further development provides several channels, which preferably have a radially nested arrangement. For example, given three channels, this means that a first channel is circularly formed on a first circle concentric to the longitudinal axis, a second channel is circularly formed on a second circle concentric to the longitudinal axis, wherein the second circle has a larger radius than the first circle, and a third channel is circularly formed on a third circle concentric to the longitudinal axis, wherein the third circle has a larger radius than the second circle. The channels are fabricated by not melting the powder in the area of the channels during manufacture. The powder remains in the channels, since it additionally has a favorable effect on the damping properties.

In addition, it makes sense that a chamber provided with preferably a circular cross section, preferably concentric to the longitudinal axis, be formed in the hub section. This advantageously makes it possible on the one hand to save on a material to be printed, thereby further shortening the manufacturing time, and on the other to use the chamber as a pre-balancing or balancing chamber, so that forces caused by unbalances can be reduced. During manufacture, the powder in the area of the pre-balancing chamber is not melted, and then removed from the suction device through a passage opening extending in the radial direction.

It is here especially preferred that the clamping section be designed in such a way that both the blades and the inlet and outlet openings of blade channels respectively formed between adjacent blades lie around the clamping section. As a result, the woodchips and/or dust particles created by a cutting tool received in the clamping section can be guided radially outward through the blade channels and away from the cutting tool, and hence from the workpiece to be machined.

In addition, it is advantageous for the clamping section that is preferably designed as a truncated cone or parabolic frustum to taper in an axial direction to a distal end, i.e., a tool-side end or a ring section-side end, of the suction device. A radial outer circumferential surface of the clamping section most preferably forms an angle relative to the longitudinal axis of the suction device of at most 10°, preferably of at most 5°, and further preferably of 2 to 4°. As a result, suitable flow properties are generated for the clamping section to maximize the suction flow or suction power.

Furthermore, it makes sense for the clamping section to form an axially flush seal with the ring section. In other words, it is preferred that the segment from the hub section to the ring section extend in an axial direction at least over half the extension length, preferably over at least 90% of the extension length, and further preferably over the entire extension length, of the suction device. As a result, the extension length of the suction device is optimally utilized in a suitable manner.

It is also advantageous for the clamping section to have a hydraulic chuck or a collet chuck mechanism. In this way, it is advantageously ensured that a cutting tool to be received in the clamping section can be clamped in a precisely centered manner. This prevents a decentering or offset from arising, along with a resultant unbalance. In an advantageous further development, the angle of attack for the blades can change in a radial and/or axial direction over the blade extension.

Furthermore, it is advantageous for the blades and the ring section to form a bucket wheel with the tool-side, continuously annular suction opening, i.e., with a continuous annular cross section, and a plurality of circumferential discharge openings. The discharge openings here correspond to the outlet openings of the blade channels, which are formed on the radial outer circumference of the bucket wheel. In particular, it is preferred that the blade channels extend out from the hub section up to the ring section.

In addition, it is preferred that the longitudinal edges of the outlet openings be oriented essentially parallel to each other. The outlet openings here extend essentially perpendicular to a radial direction of the suction device, so that the woodchips can be conveyed (away) outwardly in a radial direction.

It is further advantageous for the suction device to be arranged in a machine tool machining area, in which a rinsing flow is generated so as to remove the woodchips and/or the dust from the machine tool machining area. In a preferred further development, the rinsing flow takes the form of a transverse flow in the machine tool machining area, which is oriented perpendicular to the longitudinal axis of the suction device.

The invention also relates to a chuck for rotary driven cutting tools, with a shaft section, a clamping section for non-positively clamping a rotary driven cutting tool, and a suction device according to the invention non-rotatably fixed on the clamping section for suctioning woodchips and/or dust that arises while machining a workpiece.

The object of the invention is also achieved by a method for manufacturing a suction device according to the invention, in particular for a chuck, wherein the method consists of the following steps: Determining a suction power required for the suction process in an area of engagement of a cutting tool with respect to speed and volume; generating a calculation model for configuring a plurality of blades of the suction device; optimizing the blade configuration in the calculation model with respect to a generated suction power; and additively fabricating the calculation model.

The advantage to this is that, depending on the application of the suction device, the blades can be configured in such a way as to optimize the suction power for the corresponding application. Additively fabricating the suction device makes it possible to produce complex geometries, which correspond to a calculation model for the suction device, in particular the blades, that has been optimized with respect to a suction power to be generated.

### BRIEF DESCRIPTION OF THE FIGURES

The invention will be described below with the help of drawings. Shown on:

FIG. 1 is half a longitudinal sectional view of a suction device according to the invention, which is fastened to a shaft section,

FIG. 2 is a longitudinal sectional view of the suction device and the shaft section along line II-II,

FIG. 3 is a cross sectional view of a hub section of the suction device along line III-III depicted on FIG. 1,

FIG. 4 is a front view of the suction device,

FIG. 5 is a longitudinal sectional view of the suction device along line IV-IV depicted on FIG. 4,

FIG. 6 is a longitudinal sectional view of the suction device along line VI-VI depicted on FIG. 4,

FIG. 7 is a perspective side view of the suction device with the shaft section,

FIG. 8 is a perspective front view of the suction device,

FIG. 9 is an inclined, perspective view from in front of the suction device, and

FIG. 10 is a schematic, inclined, perspective view from above the suction device.

### DESCRIPTION OF THE EXEMPLARY EMBODIMENTS

The figures are only schematic in nature, and serve exclusively for understanding the invention. The same elements are labeled with the same reference number.

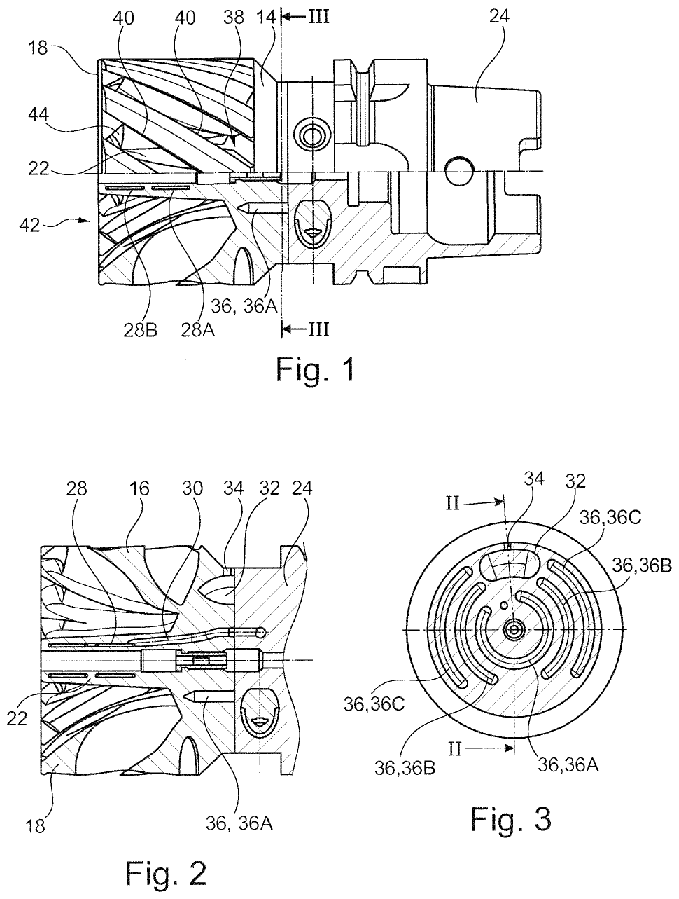

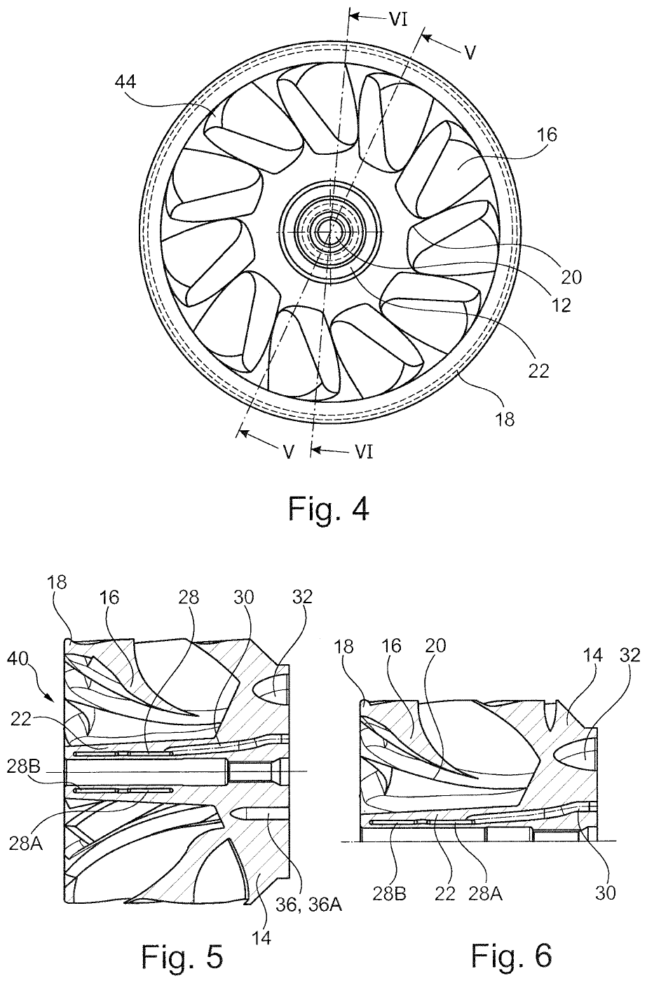

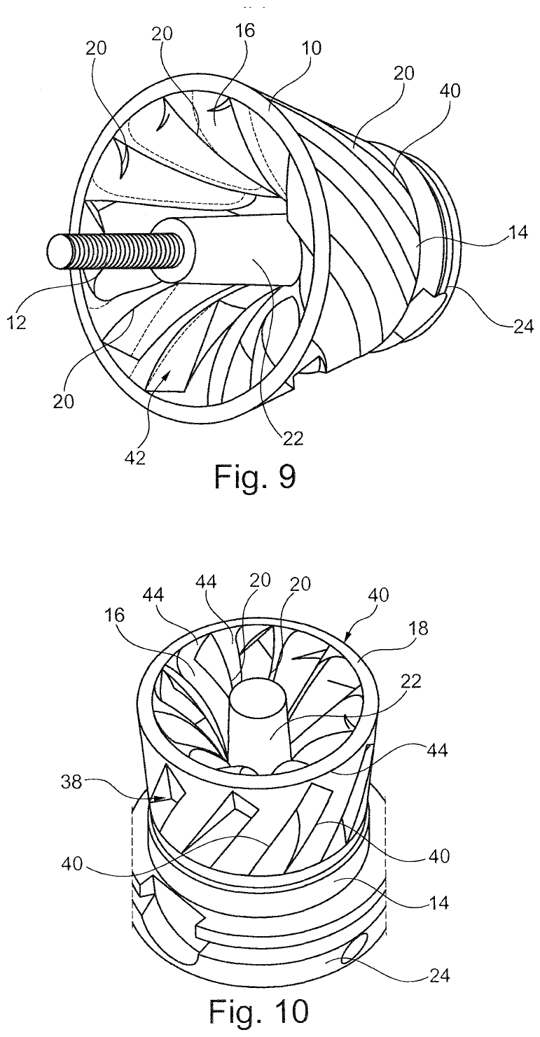

FIGS. 1 to 10 show a suction device according to the invention, which is part of a chuck 10. A cutting tool 12 can be received in the chuck 10. The suction device has a rotary driven hub section 14. A plurality of radial blades or blades 16 extends from the hub section 14 in an axial direction, wherein the blades 16 are uniformly distributed in the circumferential direction of the hub section 14. The blades 16 extend from the hub section 14 up to a ring section 18 arranged coaxially, but spaced axially apart from the hub section 14. The hub section 14, the blades 16 and the ring section 18 comprise a cage-like, materially integral unit, which is also referred to as a bucket wheel.

The blades 16 each have a blade leading edge 20, which forms a radial inner edge of the blade 16 or the blade surface. The blade leading edge 20 extends axially away from the hub section 14 and radially outward, and passes over into the ring section 18. The ring section 18 thus stabilizes the blades 16. The radial distance between the longitudinal axis of the suction device and the respective blade leading edges 20 thus becomes larger with an increasing extension length from the hub section 14 to the ring section 18.

A clamping section 22 for receiving the cutting tool 12 is formed radially inside the ring section 18, and has the blades 16 arranged around it. The clamping section 22 is arranged coaxially to the ring section 18 and the hub section 14. A shaft section 24 adjoins the hub section 14 in an axial direction on a side facing away from the ring section. The hub section 14, the blades 16, the ring section 18 as well as the clamping section 22 are printed onto the shaft section 24 via 3D printing, so that they form a non-detachably interconnected unit.

The clamping section 22 has a hydraulic clamping area 26 with two pressure chambers 28. A first pressure chamber 28A is hydraulically connected with a second pressure chamber 28B axially offset relative to the first pressure chamber 28A. The pressure chambers 28 can be pressurized via a hydraulic channel 30, so that an elastically flexible partition wall deforms radially inward radially between the pressure chambers 28 and a workpiece receiving section, thereby yielding a centered clamping of the cutting tool 12 in a clamping section 22. The hydraulic channel 30 is connected with a hydraulic port in the shaft section 24 in a fluid-conducting manner. Such hydraulic chucks are known in the art, making any description of the details unnecessary.

A radial outer diameter of the clamping section 22 tapers continuously from a hub section-side end of the clamping section 22 to a ring section-side end of the clamping section 22. The clamping section 22 thus has a conical, radial outer circumferential surface. The clamping section 22 abuts axially flush with the ring section 18 at the ring section-side end of the clamping section 22, and passes over into the hub section 14 at the hub section-side end of the clamping section 22.

In an alternative embodiment, the suction device can also be designed without the clamping section 22, even if this is not shown in the drawings.

FIG. 3 shows a cross section of the hub section 14. The hub section 14 has a pre-balancing chamber 32, which has a circular cross section. The pre-balancing chamber 32 is connected with a radial outer circumference of the hub section 14 via a passage opening 34 that extends in the radial direction.

Several C-shaped or circularly shaped channels 36 are present in the hub section 14. A first channel 26A is here arranged along a first circle that is concentric to the longitudinal axis of the hub section 14. Two second channels 36B are arranged along a second circle that is concentric to the longitudinal axis of the hub section 14, and has a larger diameter than the first circle. The two second channels 36B are arranged symmetrically to a plane of symmetry that contains the longitudinal axis. Two third channels 36C are arranged along a third circle that is concentric to the longitudinal axis of the hub section 14, and has a larger diameter than the second circle. The two third channels 36C are arranged symmetrically to the plane of symmetry. The pre-balancing chamber 32 is arranged along a circle that is concentric to the longitudinal axis of the hub section 14, and has a diameter larger than that of the second circle, and smaller than that of the third circle. The second channels 36B and the third channels 36C each extend over a length of ⅛ to ¼, preferably of about ⅙, of the circumference of the second or the third circle. The first channel 36A extends over a length of ¾ of the circumference to over the entire circumference of the first circle, preferably over a length of about ⅞ of the circumference of the first circle.

As evident from FIG. 2, the channels 36 and the pre-balancing chamber 32 extend in an axial direction up to a shaft-side end of the hub section 14, as well as up to an attachment of the blades 16. The width of the channels and the pre-balancing chamber 32 here tapers as measured in the radial direction toward the blades 16.

The blades 16 or longitudinal axes of the blades 16 are inclined relative to the axial direction of the suction device along the circumferential direction. The blades or longitudinal axes of the blades 16 are also inclined relative to the radial direction of the suction device along the axial direction.

In other words, the longitudinal axes of the blades 16 each run from a hub section-side end to a ring section-side end as viewed in the radial direction, from the inside out and oriented so as to run together in the rotational direction in the circumferential direction. The blades 16 are therefore positioned both in the radial direction and in the axial direction, wherein the angle of attack changes over the blade extension.

A blade channel 38 is formed between a respective two circumferentially adjacent blades 16. The blade channels 38 each have an outlet opening, which is formed on the radial outer circumference of the bucket wheel. The outlet openings coincide with the discharge openings of the bucket wheel. The blades 16 have a triangularly shaped cross section, which is formed by the blade leading edges 20 as well as a respective two blade trailing edges 40 lying on the radial outer circumference of the bucket wheel. The blade trailing edges 40 correspond to the longitudinal edges of the discharge openings of the bucket wheel or the outlet openings of the blade channels 38.

The blade trailing edges 40 are essentially parallel to each other and positioned in an axial direction, so that a length of the blade trailing edges 40 is greater than the extension length of the blades 16 in an axial direction. The blade leading edges 20 curvedly extend in an axial direction away from the hub section 14 and radially outward, wherein the curvature increases with increasing distance from the hub section 14, i.e., the radius of curvature of the blade leading edges 20 decreases with increasing distance from the hub section (see FIGS. 5 and 6).

A continuously ring-shaped suction opening 42 is formed at the tool-side end of the bucket wheel, and is concentric to the clamping section 22. A larger suction opening here has a positive effect on the generatable suction power.

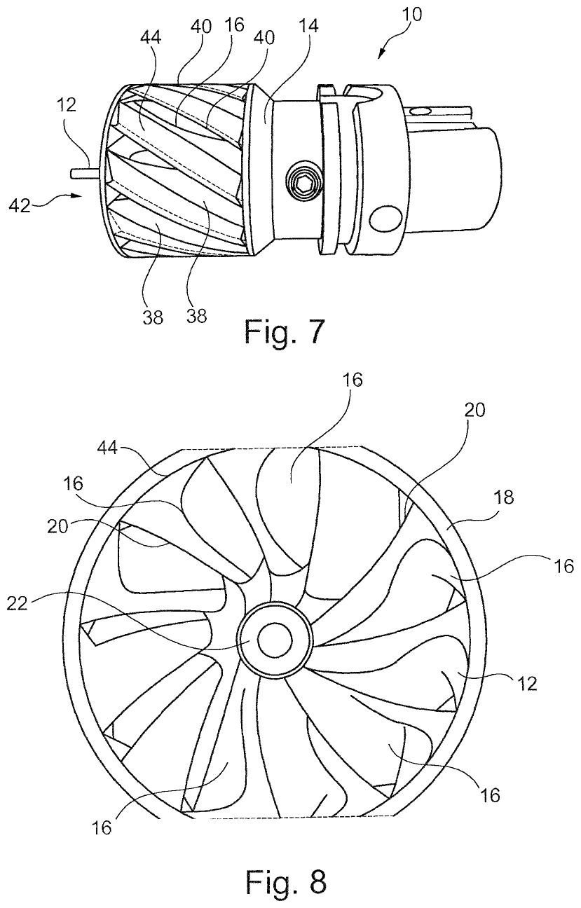

The bucket wheel is manufactured integrally with the clamping section 22 in a 3D printing process. The bucket wheel and the clamping section 22 are here fabricated from a shaft-side end, and pressed onto the shaft section 24, thereby forming a non-detachable unit comprised of the shaft section 24, the clamping section 22, and the bucket wheel. A radial outer circumferential surface of the hub section 14 passes over into a radial outer circumferential surface of the shaft section 22. This means that no ledge arises between the shaft section 24 and the bucket wheel. During production, the bucket wheel and the clamping section 22 are applied layer by layer in an axial direction. For purposes of manufacturability, a triangle-resembling section 44 is present between the transitional area between the ring section 18 and the blades 16, the outer edges of which each comprise an obtuse angle with the blades 16 and the ring section 18 (see FIGS. 7 to 10).

The suction device is used in a machine tool machining area by generating a rising flow that streams perpendicular to the longitudinal axis of the suction device. The rinsing flow is designed in such a way as to run away from the suction device in a radial direction and out of the machine tool machining area.

The structural design described above results in the following working method: While machining with the cutting tool 12 received in the chuck 10, the clamping section 22 is driven in a rotational direction around a spindle axis. Because the bucket wheel, i.e., the hub section 14, the blades 16, and the ring section 18, is integrally designed with the clamping section 22, the bucket wheel is also driven in the machining process. The configuration of the blades 16 here creates a suction flow that streams from the tool-side, continuously ring-shaped suction opening 42 of the bucket wheel through the blade channels 38 to the discharge openings on the outer circumference of the bucket wheel. This suction flow aspirates arising woodchips and dust from a workpiece surface to be machined, transporting them along with the suction flow. The woodchips and/or the dust exiting the discharge openings are then picked up by the rinsing flow in the machine tool machining area, and transported perpendicularly to the spindle axis, away from the suction device and out of the machine tool machining area.

1. A suction device for suctioning off woodchips and/or dust that arises during the cutting machining of a workpiece,
with a rotationally drivable hub section, which carries a plurality of radial blades that are uniformly distributed in a circumferential direction, wherein a respective blade leading edge of the blade extends axially away from the hub section and radially outward up to a ring section that is concentric to the hub section and stabilizes the blades.

2. The suction device according to claim 1, wherein an outer diameter of the hub section, the ring section, and/or the blades forms a shared enveloping cylinder, a shell surface of which surrounds the suction device.

3. The suction device according to claim 1, wherein the blades are positioned in an axial direction and/or in a radial direction.

4. The suction device according to claim 1, wherein the blades have a continuously running blade cross section over more than half the extension length of the suction device along its longitudinal axis.

5. The suction device according to claim 1, wherein the suction device is inherently integral in design.

6. The suction device according to claim 1, wherein the suction device is generatively fabricated.

7. The suction device according to claim 1, wherein the hub section is integrally designed with a clamping section of the chuck.

8. The suction device according to claim 7, wherein the clamping section forms an axially flush seal with the ring section.

9. The suction device according to claim 7, wherein the clamping section has a hydraulic clamping area or a collet chuck mechanism.

10. The suction device according to claim 3, wherein the angle of attack of the blades changes in a radial and/or axial direction over the blade extension.

11. A method for manufacturing a suction device according to claim 1, wherein the method comprises the following steps:
determining a suction power required for a suction process in an area of engagement of a cutting tool with respect to speed and volume;
generating a calculation model for configuring a plurality of blades of the suction device;
optimizing a blade configuration in the calculation model with respect to a generated suction power; and
additively fabricating the calculation model.
